(19) United States
(12) Patent Application Publication
(10) Pub. No.: US 2025/0086219 A1
(43) Pub. Date: Mar. 13, 2025

(54) SYSTEMS AND METHODS FOR IDENTIFYING ALERT CHARACTERISTICS FROM EARLY SEQUENCING

(71) Applicant: Fidelity Information Services, LLC, Jacksonville, FL (US)

(72) Inventors: John C. PLATAIS, Menomonee Falls, WI (US); Ranadhir GHOSH, St Johns, FL (US)

(21) Appl. No.: 18/463,584

(22) Filed: Sep. 8, 2023

(51) Int. Cl. G06F 16/34; G06F 16/35

(52) U.S. Cl. CPC G06F 16/345; G06F 16/35

(57) ABSTRACT

A computer implemented method for identifying alert characteristics, the method including: receiving multiple alerts, each alert including a set of alert characteristics including an alert key, a text summary, and a time stamp of when the alert was received; preprocessing the multiple alerts; performing a first clustering algorithm on the summary field vectors for the multiple alerts to determine multiple clusters, classifying each alert into a corresponding cluster; generating a sequence for each block based on the clusters assigned to the alerts sorted into the block; performing a sequence embedding algorithm on the sequence for each block to generate a sequence embedding for the block; performing principal component analysis on the sequence embedding for each block; and performing a second clustering algorithm on the blocks, wherein the second clustering associates and groups blocks that have a similar pattern of alerts.

### TECHNICAL FIELD

Various embodiments of the present disclosure relate generally to processing incident data and, more particularly, identifying alert characteristics from early sequencing of alerts.

### BACKGROUND

Changes to any type of system creates some degree of risk that the system will not continue to perform as expected. Additionally, even if system performance is not immediately affected, a change to a system may cause issues later, and a significant amount of time and resources may need to be expended to determine what caused the change in performance of the system.

For example, in software, deploying, refactoring, or releasing software code has different kinds of associated risk depending on what code is being changed. Not having a clear view of how vulnerable or risky a certain code deployment may be increases the risk of system outages. Deploying code always includes risks for a company, and platform modernization is a continuous process. A technology shift is a big event for any product, and entails a large risk as well as opportunity for a software company.

Outages and/or incidents cost companies money in service-level agreement payouts, but more importantly, wastes time for personnel via rework, and may risk adversely affecting a company's reputation with its customers. Highest costs are attributed to bugs reaching production, including a ripple effect and a direct cost on all downstream teams. Also, after a modification has been deployed, an incident team may waste time determining what caused a change in performance of a system.

Modern IT architectures have become increasingly complex. Understanding and resolving alerts from a large system across the IT landscape frequently involves decentralized personnel and systems, and individual ticket and time-separated resolutions, resulting in significant inefficiencies in large IT organizations.

The present disclosure is directed to overcoming one or more of the above-referenced challenges.

### SUMMARY OF THE DISCLOSURE

In some aspects, the techniques described herein relate to a method for identifying alert characteristics, the method including: receiving multiple alerts, each alert including a set of alert characteristics including an alert key, a text summary, and a time stamp of when the alert was received; preprocessing the multiple alerts, the preprocessing including: performing a term frequency-inverse document frequency algorithm on the text summary of each alert to determine summary field vectors; sorting the multiple alerts into blocks based on the time stamps of the multiple alerts; performing a first clustering algorithm on the summary field vectors for the multiple alerts to determine multiple clusters, classifying each alert into a corresponding cluster; generating a sequence for each block based on the clusters assigned to the alerts sorted into the block; performing a sequence embedding algorithm on the sequence for each block to generate a sequence embedding for the block; performing principal component analysis on the sequence embedding for each block; and performing a second clustering algorithm on the blocks, wherein the second clustering associates and groups blocks that have a similar pattern of alerts.

In some aspects, the techniques described herein relate to a method, wherein preprocessing the multiple alerts further includes: converting the alert key of each alert to a value by performing an encoding algorithm.

In some aspects, the techniques described herein relate to a method, wherein sorting the multiple alerts includes: identifying a time difference between the time stamps of the multiple alerts.

In some aspects, the techniques described herein relate to a method, wherein sorting the multiple alerts further includes: applying an algorithm to determine a mean and standard deviation of the time that each alert was received; and determining the blocks based on the mean and standard deviation of the time that each alert was received.

In some aspects, the techniques described herein relate to a method, further including assigning each of the multiple clusters an alphabetical and/or numeric character.

In some aspects, the techniques described herein relate to a method, wherein performing principal component analysis converts the sequence embedding for each block to multiple dimensions.

In some aspects, the techniques described herein relate to a method, wherein performing a second clustering algorithm on the blocks determines groupings of the blocks.

In some aspects, the techniques described herein relate to a method, wherein the multiple alerts are received over a time period of at least a month.

In some aspects, the techniques described herein relate to a method, wherein performing a term frequency-inverse document frequency algorithm on the text summary of each alert determines common terms utilized to describe the alert within the text summary of the alert.

In some aspects, the techniques described herein relate to a method, wherein the alerts classified into a same cluster include similar content in the corresponding text summaries.

In some aspects, the techniques described herein relate to a method, wherein performing a sequence embedding algorithm on the sequence for each block creates a vector with standardized dimensions.

In some aspects, the techniques described herein relate to a method, wherein performing principal component analysis converts the sequence embedding to two dimensions.

In some aspects, the techniques described herein relate to a system for identifying alert characteristics, the system including, a memory to store instructions; and at least one processor to execute the stored instructions to perform a method including: receiving multiple alerts, each alert including a set of alert characteristics including an alert key, a text summary, and a time stamp of when the alert was received; preprocessing the multiple alerts, the preprocessing including: performing a term frequency-inverse document frequency algorithm on the text summary of each alert to determine summary field vectors; sorting the multiple alerts into blocks based on the time stamps of the multiple alerts; performing a first clustering algorithm on the summary field vectors for the multiple alerts to determine multiple clusters, classifying each alert into a corresponding cluster; generating a sequence for each block based on the clusters assigned to the alerts sorted into the block; performing a sequence embedding algorithm on the sequence for each block to generate a sequence embedding for the block; performing principal component analysis on the sequence embedding for each block; and performing a second clustering algorithm on the blocks, wherein the second clustering associates and groups blocks that have a similar pattern of alerts.

In some aspects, the techniques described herein relate to a system, wherein preprocessing the multiple alerts further includes: converting the alert key of each alert to a value by performing an encoding algorithm.

In some aspects, the techniques described herein relate to a system, wherein sorting the multiple alerts includes: identifying a time difference between the time stamps of the multiple alerts.

In some aspects, the techniques described herein relate to a system, wherein sorting the multiple alerts further includes: applying an algorithm to determine a mean and standard deviation of the time that each alert was received; and determining the blocks based on the mean and standard deviation of the time that each alert was received.

In some aspects, the techniques described herein relate to a system, further including assigning each of the multiple clusters an alphabetical and/or numeric character.

In some aspects, the techniques described herein relate to a system, wherein performing principal component analysis converts the sequence embedding for each block to multiple dimensions.

In some aspects, the techniques described herein relate to a system, wherein performing a second clustering algorithm on the blocks determines groupings of the blocks.

In some aspects, the techniques described herein relate to a non-transitory computer readable medium storing instructions that, when executed by at least one processor, cause the at least one processor to perform a method including: receiving multiple alerts, each alert including a set of alert characteristics including an alert key, a text summary, and a time stamp of when the alert was received; preprocessing the multiple alerts, the preprocessing including: performing a term frequency-inverse document frequency algorithm on the text summary of each alert to determine summary field vectors; sorting the multiple alerts into blocks based on the time stamps of the multiple alerts; performing a first clustering algorithm on the summary field vectors for the multiple alerts to determine multiple clusters, classifying each alert into a corresponding cluster; generating a sequence for each block based on the clusters assigned to the alerts sorted into the block; performing a sequence embedding algorithm on the sequence for each block to generate a sequence embedding for the block; performing principal component analysis on the sequence embedding for each block; and performing a second clustering algorithm on the blocks, wherein the second clustering associates and groups blocks that have a similar pattern of alerts.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system overview for a data pipeline for data transfer and aggregation, according to one or more embodiments.

FIG. 2 depicts a flow diagram illustrating an exemplary process for identifying blocks of alerts based on alert characteristics.

FIG. 3 depicts an exemplary flowchart for identifying alert characteristics from sequencing, according to one or more embodiments.

FIG. 4 depicts an exemplary flowchart for identifying alert characteristics from sequencing, according to one or more embodiments.

FIG. 5 illustrates a computer system for executing the techniques described herein, according to one or more embodiments of the present disclosure.

### DETAILED DESCRIPTION OF EMBODIMENTS

Various embodiments of the present disclosure relate generally to processing incident data and, more particularly, identifying alert characteristics from early sequencing of alerts.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. The announcement of vulnerabilities and issues may be reported by alerts.

An alert may refer to a notification that informs a system or user of an event. An alert may include a collection of events representing a deviation from normal behavior for a system. For example, an alert may include metadata including a short field description that includes free from text fields (e.g., a summary of the alert), first occurrences, time stamps, an alert key, etc. Understanding the different types of alerts within a system from various perspectives may assist in resolving incidents.

For example, an IT management system may receive alerts at invariable rates throughout the day. When alerts are received, it may be unclear as to how a particular alert relates to previous or future alerts. Better understanding the relationship between received alerts may assist a user or a system in identifying and potentially addressing incidents for a system.

Processing a vast amount of information, such as alerts, to produce meaningful and actionable insights in information technology IT operations may be valuable to organizations. As IT management systems utilize sophisticated tools and sensors, billions of data points may be received and information overload may become an issue to be resolved. The systems and methods described herein may enable correlation of alerts and groups of alerts to provide additional insights. The correlated alerts help a user to better understand the relationships between various alerts. This may help a user to better understand alert characteristic of various groups of alerts. Certain IT systems configured for correlating alerts may analyze a horizontal level of information and may not capture the temporal characteristic of alerts. The systems and methods described herein help address this issue. The systems and methods described herein may analyze and group alerts that occur in a variant time block and have a temporal sequencing pattern.

One or more embodiments may identify and group alert characteristics based on temporal sequencing data. Understanding various grouping of alerts within a system over a period of time, may help to better understand alert characteristics of various groups of alerts. One or more embodiments may group alerts into blocks of variable lengths based on variable lengths of time. The blocks may be created based on processed alert data (e.g., alert characteristics) and the created blocks may be configured (e.g., by clustering and sequencing algorithms) to be compared to historical/past blocks of alert data. The output format of the grouped blocks may serve as valuable information that can be utilized to predict future incidents.

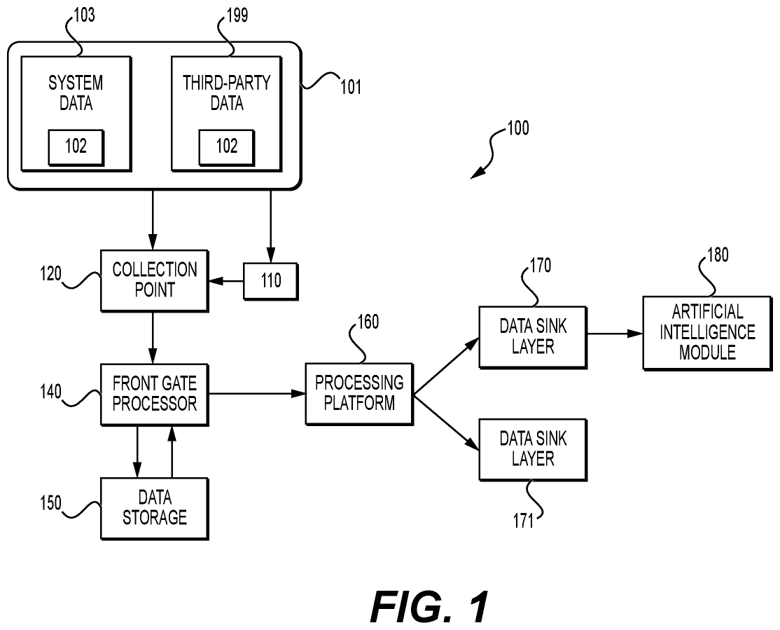

FIG. 1 depicts an exemplary system overview for a data pipeline for an artificial intelligence model to predict and troubleshoot incidents in a system, according to one or more embodiments.

FIG. 1 depicts an exemplary system overview for a data pipeline for data transfer and aggregation, according to one or more embodiments. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and an artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may for example be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but limited to JSON, CSV, Avro, ORC, HTML, XML, and Parquet. The secondary collection point 110 may encrypt incident data 102 collected from the third party data producers. The secondary collection point 110 may encrypt incident data, including, but not limited through Mutual Authentication Transport Layer Security (mTLS), HTTPS, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may for example be a software such as Apache NiFi. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may for example be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. Clusters and/or nodes may be generated that also utilize HDFS. For example, a cluster computing framework, such as the processing platform 160, may be arranged to further utilize the HDFS of the data storage 150. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., data sink layer 170, or data sink layer 171). Further, additional data that is not required at downstream modules (e.g., at the artificial intelligence module 180) may be filtered and excluded prior to transferring the data to a data sink layer.

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., data sink layer 170 and data sink layer 171). Incident data 102 processed from processing platform 160 may be transmitted to and stored in data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers may be data lakes, data warehouses, or cloud storage systems. Each data sink layer may be configured to store incident data 102 in both a structured or unstructured format. Data sink layer 170 may store incident data 102 with several different formats. For example, data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc.

The data pipeline system 100 may include an artificial intelligence module 180. The artificial intelligence module 180 may include a machine learning component. The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

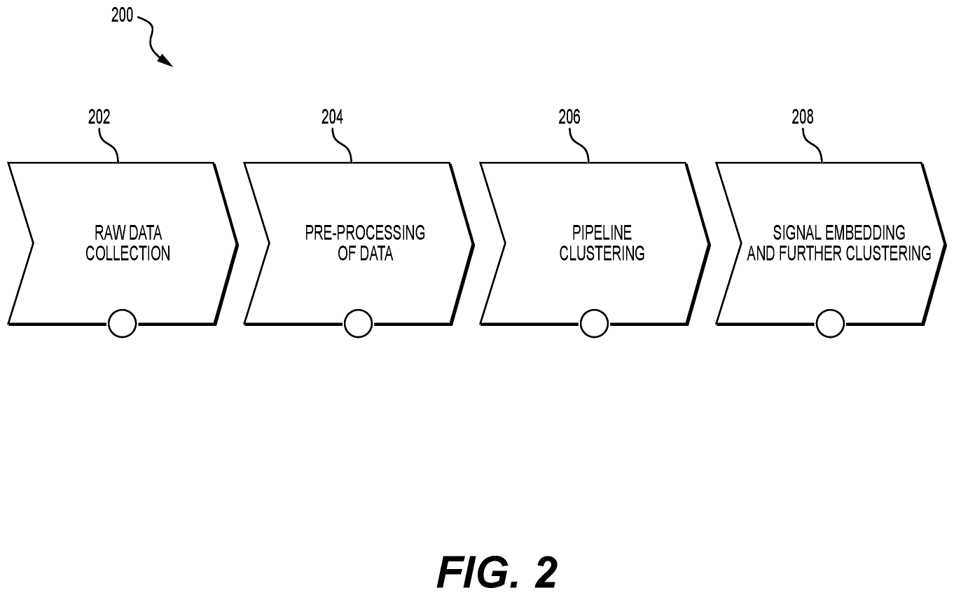

FIG. 2 is a flow diagram illustrating an exemplary process for identifying blocks of alerts based on alert characteristics, according to one or more embodiments. The process described in FIG. 2 may be implemented by the data pipeline system 100 of FIG. 1.

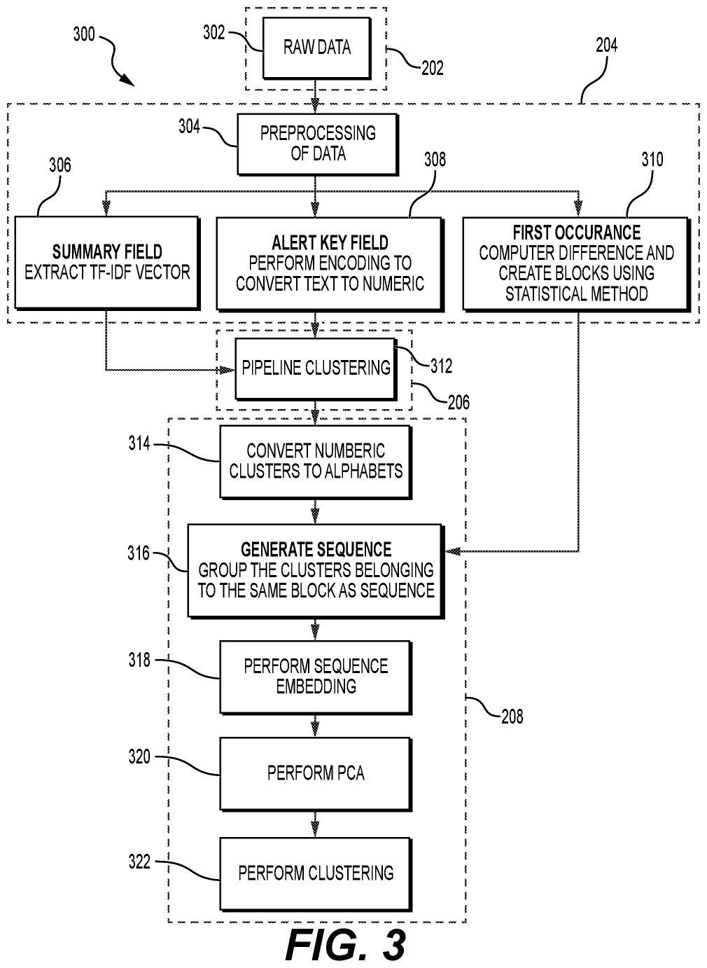

Raw data collection 202 may be performed at the data source 101 in the data pipeline system 100. The raw data collection 202 may be demonstrated by step 302 of FIG. 3. The raw data collection 202 may include receiving alerts and corresponding alert characteristic information related to an external or internal system. The alerts may have been generated automatically by monitoring systems that generate alerts when warning/critical events, outages, and/or failures in an IT environment occur. The alert may include metadata including a short text description, a time and date of first occurrence (e.g., timestamp(s)), and an alert key. The raw data collection 202 may include receiving a constant influx of raw images over time. The raw data collection 202 may include applying filters to only receive alert data. In another example, all received data within the data pipeline system 100 that is not alert-related may be excluded from processing during the pre-processing 204. This filtering may be performed by either the collection point 120, the front gate processor 140, or the processing platform 160 of the data pipeline system 100.

As the raw data collection 202 is received, the raw data may be pre-processed 204 (e.g., by the collection point 120, the front gate processor 140, or the processing platform 160 of the data pipeline system 100). The data pre-processing may be performed at steps 304-310 of FIG. 3. The data pre-processing may include extracting and processing the metadata associated with the received alerts. The pre-processing of data may include converting the text data into term frequency-invert document frequency (td-idf) vectors (e.g., summary field vectors), converting alert keys into a value (e.g., a numeric value), identifying the time difference between occurrences of alerts, and creating initial blocks of alerts as will be discussed in greater detail below.

After the data is pre-processed 204, a pipeline clustering algorithm 206 may be applied to the pre-processed data (e.g., by an Artificial Intelligence model 180). The clustering algorithm may be performed at step 312 of FIG. 3. As will be described in greater detail below, the pipeline clustering algorithm may be performed on the previously-determined summary field vectors. Thus, each alert within a previously-generated block may be symbolized by an alphabetic and/or numeric character representing a cluster, each cluster being based on the text from the summary description of the alert. Each cluster may be based on the prominence of particular terms identified within the summary field vectors.

After the first clustering algorithm 206, signal embedding and further clustering 208 may be performed (e.g., by an Artificial Intelligence model 180). The signal embedding and further clustering may be performed at steps 314-322 of FIG. 3. During this step of further processing, each cluster may first be converted from a numeric value to an alphabetic character for additional processing. Next, the alphabetic clusters belonging to the same block may be sequenced by a sequencing algorithm. For instance, a sequencing embedding may be applied to the letters of each block. This may allow for each block to be represented by a vector of alphabetic characters. Next, a principal component analysis (PCA) may be applied to the sequence embedding vectors. This PCA may convert the dimensions of the sequence embedding vectors to a multi-dimensional (e.g., two, three, four, etc.) vector capable of being further analyzed (e.g., further clustered). Lastly, a second clustering algorithm may be applied to the multi-dimensional sequenced vectors. This may allow for blocks of alerts to be grouped (e.g., clustered) based on each block's make-up of previous clustered groups. Data associated with this new clustering may be stored and/or output for future/further analysis.

FIG. 3 depicts an exemplary flowchart for identifying alert characteristics from sequencing, according to one or more embodiments. The process described in FIG. 3 may be implemented by the data pipeline system 100 of FIG. 1.

At step 302, raw data may be received by the system. For example, the raw data may include multiple alerts, each alert including a set of alert characteristics. The alert characteristics may include metadata such as an alert key, a time stamp that an alert was received, and a text summary of the alert. In one example, the system may receive a stream of alerts (and the corresponding alert characteristics) during a period of time. In another example, the system may receive sets of alerts received during different time periods over a period of time. For example, the system may receive a set of alerts from a first time interval (e.g., all alerts that a particular system received over a six month period), followed by a stream of new alerts as the system receives more alerts.

At step 304, the raw data may be preprocessed. For example, if any of the received data is not alert information (e.g., incident data), then the data may be filtered and excluded from further processing. Further, if alerts correspond to different systems (e.g., for different external systems), the data may be separated so all downstream steps of FIG. 3 are applied solely to alerts pertaining to the same system.

Next step 306, step 308, and step 310 may be performed simultaneously or at separate times. At step 306, the system may first extract the text description (e.g., text summary or summary field) from each received alert. Next, a term frequency-inverse document frequency algorithm (TD-IDF) may be applied to the text description for each alert. The TD-IDF may be a calculation to determine how relevant a word in a series of text is. The TD-IDF may output an array of terms along with TD-IDF values and return a list of feature names. These may be stored as one or more vectors. Both the array and list of feature names may be stored in a database.

Further, at step 308, the system may extract and convert the received alert keys into a value (e.g., a numeric value) utilizing encoding techniques. For example, the alert key may include alphabet, symbols, and/or numerals. The data preprocessing 204 may convert the alert key to be fully numeric. The fully numeric alert key may be saved and stored in a database for each received alert.

At step 310, the system may record and track the “first occurrence” data. This may include the time and date of the occurrence that an alert is detected. The data and time may be tracked and stored on a database. The alerts may then be organized and ordered based on time of first occurrence. The system may then determine the time intervals between the chronologically-received alerts and save these values. The system may then determine the mean and the standard deviation of the time intervals between alerts. The system may then perform a grouping algorithm on the alerts based on the time intervals of the received alerts. For example, as alerts are received, blocks of alerts may be formed. The time difference between when each alert is received may be recorded and saved. The system may perform a standard deviation on these recorded time differences. Then, as new alerts are received, the new time differences may be analyzed to determine a block. When a new alert is received, the newest time difference (e.g., the time between when the newest and previous alert were received) is recorded and compared to the historical time differences. If the newest time difference is outside a third deviation of the historical time differences, with respect to the time difference being a time greater than the average time difference at 3 derivation, then the system may assign the alert to be the first alert in a new block. Meanwhile, the last received alert may be recorded as the last alert in the previously determined block. The blocks may be saved in a database to be further analyzed (e.g., at step 316). Further, future blocks (e.g., blocks created with more recent alert data) may be compared and contrasted to past blocks (e.g., blocks created with alert data from a past time period) of alerts.

Next, at step 312, a pipeline clustering algorithm (e.g., a first clustering algorithm) may be performed on the summary fields represented by the td-idf vectors (e.g., summary field vectors). The clustering algorithm may be applied to the summary field vectors determined at step 306. For example, the clustering algorithms may be applied by the artificial intelligence model 180. Pipeline clustering may include performing algorithms including, but not limited to, affinity propagation, Agglomerative Hierarchical Clustering, Balanced Iterative Reducing and Clustering using Hierarchies (BIRCH), Density-Based Spatial Clustering of Applications with Noise (DBSCAN), Gaussian Mixture Models (GMM), K-means, mean shift clustering, mini-batch K-means, OPTICS, or spectral clustering. In one example, DBSCAN may be the preferred algorithm applied to group vectors. The pipeline clustering algorithm may analyze the determined feature names within each of the alerts. The determined clusters may be based on the amount of “feature names” within an alert. Based on the amount of feature names, each alert may be classified into a specific cluster. These clusters may be saved to storage for future processing.

The first clustering algorithm may be an algorithm trained using multiple instance learning (MIL). The MIL may use weak labeling of the list of identified features (e.g., from the summary field of each alert) to identify feature names from vector lists. Thus, clusters with similar feature names and amounts of particular feature names may be identified.

Each determined cluster may be assigned a numeric value based on the determined cluster. The numeric value assigned to a cluster may further be assigned to each alert classified into that cluster. The cluster associated with each alert may be saved to storage.

At step 314, the numeric value assigned to each alert may be converted to an alphabetic character. This may be performed by utilizing a numeric-to-alphabetical conversion algorithm. After step 314, each alert may be assigned an alphabetic character based on the particular cluster to which it was classified at step 312.

At step 316, the system may generate a sequence. Generating a sequence may include grouping sets of alerts based on the blocks determined at step 310. Next, for each block, the alphabetical characters assigned to the alerts belonging to that block (assigned based on step 314 and step 316) may form a sequence for the block. Thus, blocks of alphabetical characters, with the characters representing clusters of feature names from the extracted summary text of each alert, may be created.

An example of blocks of clusters may be shown in the graph below, where each character represent a set of cluster references for a particular block.

| Block 1 | Block 2 | Block 3 | Block 4 | Block 5 | Block 6 |
|---|---|---|---|---|---|
| ABCCDAA | ACBEFEE | CACFED | DDDEEFABBCS | AFACCA | DCA |

Next, at step 318, the system may apply a sequence embedding algorithm to the blocks of clustered alerts from step 314. This step may convert the sequence of characters (e.g., sequences) of each block into vector embeddings for further processing. For example, these vector embeddings may be utilized for further clustering and/or classifications. The sequence embedding algorithm may be for example a sequence graph transform (SGT) embedding, a lineal-London-Rabinovich (LLR) algorithm, word2vec, etc. In one example, the SGT embedding algorithm may be preferred. The SGT embedding may be advantageous in that it may embed different sized lists in a sequence that is a finite dimensional vector. The SGT embedding may easily tune the amount of different size patterns without increasing computation. After the sequence embedding, all blocks may be converted to vectors with standardized dimensions. For example, even blocks that have different amounts of alerts may have a standardized dimension. This may allow for the vectors to be more easily compared and contrasted in future analysis.

After the sequence embedding algorithm is applied, the determined vectors may be multi-dimensional. For example, the vectors, although of a standardized dimension, may include more than two dimensions. A principal component analysis may be applied to the vectors at step 320 to convert the sequence embedding vectors to two dimensions.

Performing principal component analysis may include the following steps: (1) standardizing the range of continuous initial variables; (2) computing the covariance matrix to identify correlations; (3) computing the eigenvectors and eigenvalues of the covariance matrix to identify the principal components; (4) creating a feature vector to decide the principal components; and (5) recasting the data along the principal component axes. The PCA analysis of the sequence embedded vectors may thus output two-dimensional vectors capable of being further analyzed (e.g., by an additional/second cluster algorithm).

Next, at step 322, a second clustering algorithm may be applied to the outputted two-dimensional vectors from step 320. The second clustering algorithm may be applied by a machine learning system (e.g., Artificial intelligence model 180). The machine learning system may utilize one or more machine learning techniques discussed at step 312. In one example, the pipeline clustering algorithm may include performing affinity propagation, Agglomerative Hierarchical Clustering, Balanced Iterative Reducing and Clustering using Hierarchies (BIRCH), Density-Based Spatial Clustering of Applications with Noise (DBSCAN), Gaussian Mixture Models (GMM), K-means, mean shift clustering, mini-batch K-means, OPTICS, spectral clustering, or a combination thereof.

The second clustering algorithm may be trained separately than the first clustering algorithm of step 312. The clustering algorithm may have been trained using multiple instance learning (MIL). The MIL may use weak labeling of the vectors to look for similar pattern/arrangement within the vectors outputted from step 320.

The clusters output from step 322 may group the blocks of alerts into clusters. Each grouping may represent blocks that have similar sequences of the first determined clusters. These groupings may then be output and/or saved to data storage for further use and analysis.

The system may be configured to run method 200 and 300 continuously on one or more systems. For example, the system may be run and blocks of alerts may be created (with the method 300 and 200 being applied) over a period of time, e.g., over days, weeks, months or years. The newly-created blocks may thus be compared to historical blocks created from a past time period. In one example, the system may output/save the historic/previous blocks that were clustered in the same group as a newly-created block. The output/saved blocks may allow for further analysis that may provide insight.

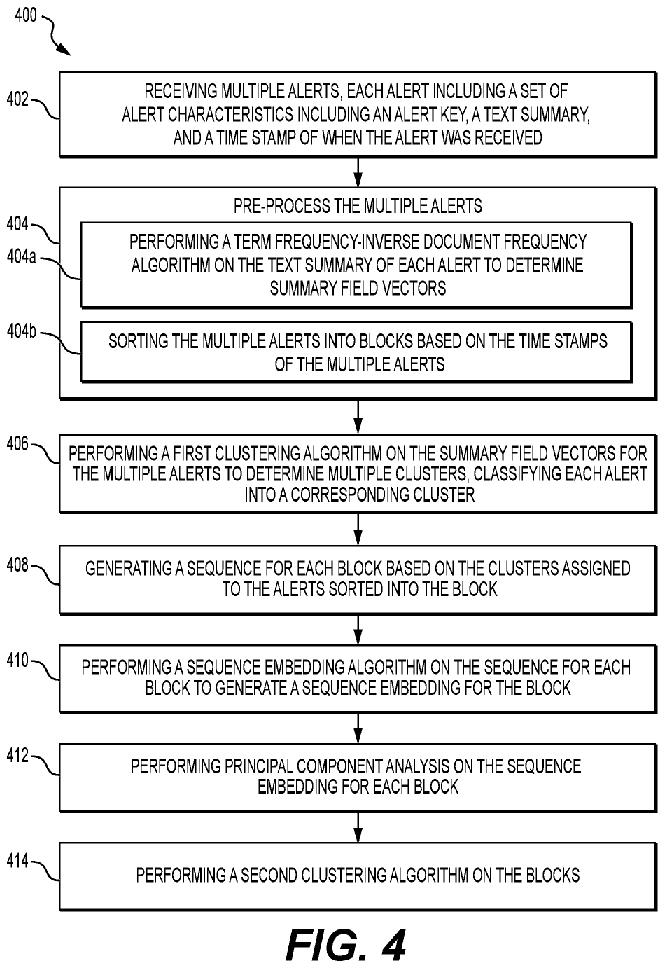

FIG. 4 depicts an exemplary flowchart 400 for identifying alert characteristics from sequencing, according to one or more embodiments.

At step 402, multiple alerts may be received, each alert including a set of alert characteristics including an alert key, a text summary, and a time stamp of when the alert was received. The multiple alerts may be received over a time period of at least a month.

At step 404, the multiple alerts may be preprocessed. This may include, for example, at step 404a performing a term frequency-inverse document frequency algorithm on the text summary of each alert to determine summary field vectors; and at step 404b sorting the multiple alerts into blocks based on the time stamps of the multiple alerts. Sorting the multiple alerts may include identifying a time difference between the time stamps of the multiple alerts. Sorting the multiple alerts may further include applying an algorithm to determine a mean and standard deviation of the time that each alert was received and determining the blocks based on the mean and standard deviation of the time that each alert was received. Performing the term frequency-inverse document frequency algorithm on the text summary of each alert may determine common terms utilized to describe the alert within the text summary of the alert. The preprocessing may further include converting the alert key of each alert to a value by performing an encoding algorithm.

At step 406, a first clustering algorithm may be performed on the summary field vectors for the multiple alerts to determine multiple clusters, classifying each alert into a corresponding cluster. The alerts classified into a same cluster may include similar content in the corresponding text summaries. Each of the multiple clusters may be assigned an alphabetical and/or numeric character.

At step 408, a sequence may be generated for each block based on the clusters assigned to the alerts sorted into the block.

At step 410, a sequence embedding algorithm may be performed on the sequence for each block to generate a sequence embedding for the block. Performing a sequence embedding algorithm on the sequence for each block may create a vector with standardized dimensions

At step 412, a principal component analysis may be performed on the sequence embedding for each block. Performing principal component analysis may convert the sequence embedding for each block to multiple dimensions. Performing principal component analysis may convert the sequence embedding to two dimensions

At step 414, a second clustering algorithm may be performed on the blocks, wherein the second clustering associates and groups blocks that have a similar pattern of alerts based on the first cluster assigned to the alerts. The second clustering algorithm may determine grouping of blocks.

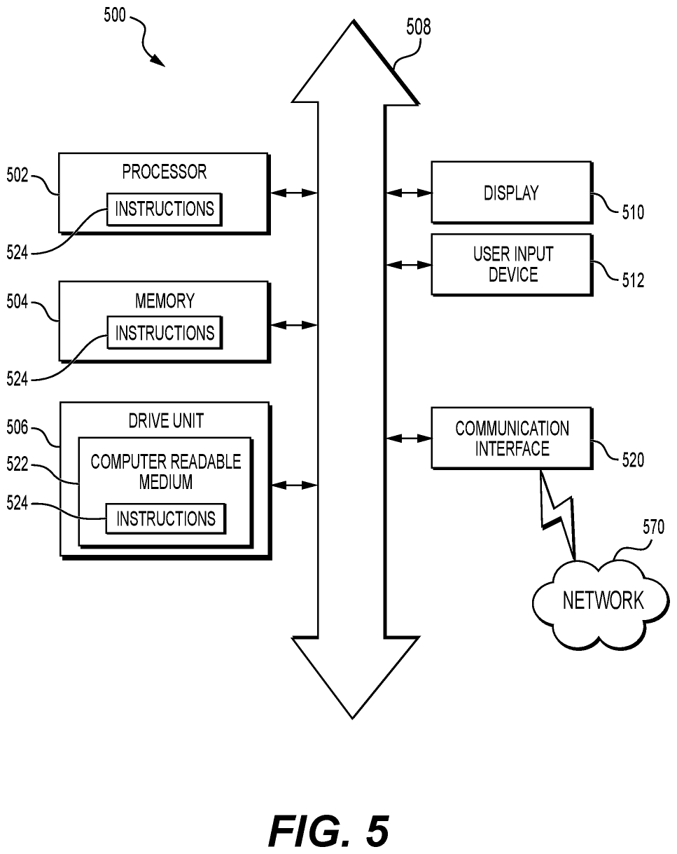

FIG. 5 illustrates an implementation of a general computer system that may execute techniques presented herein.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

FIG. 5 illustrates an implementation of a computer system 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system 500 may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 500 can be implemented using electronic devices that provide voice, video, or data communication. Further, while a computer system 500 is illustrated as a single system, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via a bus 508. The memory 504 may be a main memory, a static memory, or a dynamic memory. The memory 504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the processor 502 executing the instructions stored in the memory 504. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 500 may further include a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input device 512 configured to allow a user to interact with any of the components of computer system 500. The input device 512 may be a number pad, a keyboard, or a cursor control device, such as a mouse, or a joystick, touch screen display, remote control, or any other device operative to interact with the computer system 500.

The computer system 500 may also or alternatively include drive unit 506 implemented as a disk or optical drive. The drive unit 506 may include a computer-readable medium 522 in which one or more sets of instructions 524, e.g. software, can be embedded. Further, the instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, a computer-readable medium 522 includes instructions 524 or receives and executes instructions 524 responsive to a propagated signal so that a device connected to a network 570 can communicate voice, video, audio, images, or any other data over the network 570. Further, the instructions 524 may be transmitted or received over the network 570 via a communication port or interface 520, and/or using a bus 508. The communication port or interface 520 may be a part of the processor 502 or may be a separate component. The communication port or interface 520 may be created in software or may be a physical connection in hardware. The communication port or interface 520 may be configured to connect with a network 570, external media, the display 510, or any other components in computer system 500, or combinations thereof. The connection with the network 570 may be a physical connection, such as a wired Ethernet connection or may be established wirelessly as discussed below. Likewise, the additional connections with other components of the computer system 500 may be physical connections or may be established wirelessly. The network 570 may alternatively be directly connected to a bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 500 may be connected to a network 570. The network 570 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 570 may include wide area networks (WAN), such as the Internet, local area networks (LAN), campus area networks, metropolitan area networks, a direct connection such as through a Universal Serial Bus (USB) port, or any other networks that may allow for data communication. The network 570 may be configured to couple one computing device to another computing device to enable communication of data between the devices. The network 570 may generally be enabled to employ any form of machine-readable media for communicating information from one device to another. The network 570 may include communication methods by which information may travel between computing devices. The network 570 may be divided into sub-networks. The sub-networks may allow access to all of the other components connected thereto or the sub-networks may restrict access between the components. The network 570 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

It should be appreciated that in the above description of exemplary embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the disclosure, those skilled in the art will recognize that other and further modifications may be made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer implemented method for identifying alert characteristics, the method comprising:
receiving multiple alerts, each alert including a set of alert characteristics including an alert key, a text summary, and a time stamp of when the alert was received;
preprocessing the multiple alerts, the preprocessing including:
performing a term frequency-inverse document frequency algorithm on the text summary of each alert to determine summary field vectors; and
sorting the multiple alerts into blocks based on the time stamps of the multiple alerts;
performing a first clustering algorithm on the summary field vectors for the multiple alerts to determine multiple clusters, classifying each alert into a corresponding cluster;
generating a sequence for each block based on the clusters assigned to the alerts sorted into the block;
performing a sequence embedding algorithm on the sequence for each block to generate a sequence embedding for the block;
performing principal component analysis on the sequence embedding for each block; and
performing a second clustering algorithm on the blocks, wherein the second clustering associates and groups blocks that have a similar pattern of alerts.

2. The method of claim 1, wherein preprocessing the multiple alerts further includes:
converting the alert key of each alert to a value by performing an encoding algorithm.

3. The method of claim 1, wherein sorting the multiple alerts includes:
identifying a time difference between the time stamps of the multiple alerts.

4. The method of claim 3, wherein sorting the multiple alerts further includes:
applying an algorithm to determine a mean and standard deviation of the time that each alert was received; and
determining the blocks based on the mean and standard deviation of the time that each alert was received.

5. The method of claim 1, further comprising:
assigning each of the multiple clusters an alphabetical and/or numeric character.

6. The method of claim 1, wherein performing principal component analysis converts the sequence embedding for each block to multiple dimensions.

7. The method of claim 1, wherein performing a second clustering algorithm on the blocks determines groupings of the blocks.

8. The method of claim 1, wherein the multiple alerts are received over a time period of at least a month.

9. The method of claim 1, wherein performing a term frequency-inverse document frequency algorithm on the text summary of each alert determines common terms utilized to describe the alert within the text summary of the alert.

10. The method of claim 1, wherein the alerts classified into a same cluster include similar content in the corresponding text summaries.

11. The method of claim 1, wherein performing a sequence embedding algorithm on the sequence for each block creates a vector with standardized dimensions.

12. The method of claim 1, wherein performing principal component analysis converts the sequence embedding to two dimensions.

13. A system comprising:
a memory having processor-readable instructions stored therein; and
at least one processor configured to access the memory and execute the processor-readable instructions which, when executed by the at least one processor, configure the at least one processor to perform operations comprising:
receiving multiple alerts, each alert including a set of alert characteristics including an alert key, a text summary, and a time stamp of when the alert was received;
preprocessing the multiple alerts, the preprocessing including:
performing a term frequency-inverse document frequency algorithm on the text summary of each alert to determine summary field vectors; and
sorting the multiple alerts into blocks based on the time stamps of the multiple alerts;
performing a first clustering algorithm on the summary field vectors for the multiple alerts to determine multiple clusters, classifying each alert into a corresponding cluster;
generating a sequence for each block based on the clusters assigned to the alerts sorted into the block;
performing a sequence embedding algorithm on the sequence for each block to generate a sequence embedding for the block;
performing principal component analysis on the sequence embedding for each block; and
performing a second clustering algorithm on the blocks, wherein the second clustering associates and groups blocks that have a similar pattern of alerts.

14. The system of claim 13, wherein preprocessing the multiple alerts further includes:
converting the alert key of each alert to a value by performing an encoding algorithm.

15. The system of claim 13, wherein sorting the multiple alerts includes:
identifying a time difference between the time stamps of the multiple alerts.

16. The system of claim 15, wherein sorting the multiple alerts further includes:
applying an algorithm to determine a mean and standard deviation of the time that each alert was received; and
determining the blocks based on the mean and standard deviation of the time that each alert was received.

17. The system of claim 13, the operations further comprising:
assigning each of the multiple clusters an alphabetical and/or numeric character.

18. The system of claim 13, wherein performing principal component analysis converts the sequence embedding for each block to multiple dimensions.

19. The system of claim 13, wherein performing a second clustering algorithm on the blocks determines groupings of the blocks.

20. A non-transitory computer readable medium storing processor-readable instructions which, when executed by at least one processor, cause the at least one processor to perform operations including:
receiving multiple alerts, each alert including a set of alert characteristics including an alert key, a text summary, and a time stamp of when the alert was received;
preprocessing the multiple alerts, the preprocessing including; and
performing a term frequency-inverse document frequency algorithm on the text summary of each alert to determine summary field vectors;
sorting the multiple alerts into blocks based on the time stamps of the multiple alerts;
performing a first clustering algorithm on the summary field vectors for the multiple alerts to determine multiple clusters, classifying each alert into a corresponding cluster;
generating a sequence for each block based on the clusters assigned to the alerts sorted into the block;
performing a sequence embedding algorithm on the sequence for each block to generate a sequence embedding for the block;
performing principal component analysis on the sequence embedding for each block; and
performing a second clustering algorithm on the blocks, wherein the second clustering associates and groups blocks that have a similar pattern of alerts.
